(19) United States
(12) Patent Application Publication
(10) Pub. No.: US 2019/0289674 A1
(43) Pub. Date: Sep. 19, 2019

(54) ELECTRIC HEATING DEVICE FOR MOBILE APPLICATIONS

(71) Applicant: WEBASTO SE, Stockdorf (DE)

(72) Inventors: Tino KLINKMÜLLER, Stockdorf (DE); Stephan BUCKL, Stockdorf (DE); Daniel ECKERT, Stockdorf (DE); Karl GÖTTL, Stockdorf (DE); Andreas SCHMIDMAYER, Stockdorf (DE)

(21) Appl. No.: 16/339,976

(22) PCT Filed: Oct. 5, 2017
(86) PCT No.: PCT/EP2017/075414

§ 371 Date: Apr. 5, 2019

(30) Foreign Application Priority Data
Oct. 5, 2016 (DE) 10 2016 118 829.8

(51) Int. Cl. H05B 3/26; H05B 3/16

(52) U.S. Cl. CPC H05B 3/262; H05B 2203/023; H05B 2203/013; H05B 3/16

(57) ABSTRACT

An electrical heating device for mobile applications, includes a substrate and a heat-conducting layer formed on the substrate. The heat-conducting layer has at least one heat-conducting track that is arranged on the substrate, and the heat-conducting track is structured such that a multiplicity of track sections, separated from one another by insulating gaps, is formed. The heat-conducting track has at least one deflection section at which the heat-conducting track is deflected and which is arranged between a first and a second track section, wherein the first and the second track section have a smaller curvature in comparison with the deflection section. The heat-conducting track in the first track section or in the deflection section branches into at least two branch tracks separated from one another by one or more branch insulating gaps. The branch tracks meet up again in the second track section or in the deflection section.

The disclosure relates to an electrical heating device for mobile applications according to claim 1, and to a vehicle, in particular a motor vehicle, comprising an electrical heating device.

WO 2013/186106 A1 describes an electrical heating device for a motor vehicle having a heating resistor designed as a conductor track on a substrate. The conductor track is designed so as to be bifilar, and a widened insulation region is provided in the region of a conductor track deflection in the opposite direction. The widened insulation region is intended to bring about an effect whereby a flow of current occurs as far as possible through the full width of the conductor track, in order to avoid a situation whereby regions that are flowed through to a particularly great extent are able to form locally on the inside and regions that are flowed through to a small extent are able to form in the outside edge region of the conductor track. In this context, however, it has proven that, in comparison with the rest of the electrical heating device, a comparatively greatly increased temperature may still occur in the region of the conductor track deflection.

The object of the present disclosure is to propose an electrical heating device and a corresponding vehicle, in particular a motor vehicle, in which a comparatively homogeneous temperature distribution is achieved, the electrical heating device being intended to be as compact and inexpensive in terms of production as possible.

The object is achieved in particular by an electrical heating device for mobile applications, having: a substrate and a heat-conducting layer formed on the substrate, wherein the heat-conducting layer has at least one heat-conducting track that extends on the substrate (in a main plane), wherein the heat-conducting track is structured such that a multiplicity of track sections (running adjacent to one another, in particular at substantially the same height with respect to the substrate), separated from one another by insulating gaps, is formed, wherein the heat-conducting track has at least one deflection section at which the heat-conducting track is deflected (in the main plane) and which is arranged (directly) between a first and a second track section, wherein the first and the second track section have a smaller curvature in comparison with the deflection section, in particular are designed so as to be at least substantially straight, wherein the heat-conducting track in the first track section or in the deflection section branches into at least two branch tracks separated from one another by one or more branch insulating gaps, wherein the branch tracks meet up again in the second track section or in the deflection section.

One significant aspect of the disclosure is that one or more additional conductor tracks are provided in the region of the deflections (deflection sections). A comparatively homogeneous current density distribution is thereby achieved. High temperatures at the deflection points (deflection sections) having a correspondingly high load for the heating device are thereby able to be avoided using simple means. The robustness of the heating device is thereby improved. In principle, the temperature in the deflection sections is also able to be reduced by virtue of the fact that the deflection section is (locally) provided with a material with good electrical conduction. Such a (local) coating with a material with good conduction however has the disadvantage that an additional method step has to be performed (during production) (for example masking and/or coating). Furthermore, subsequent layers (for example a sensor layer) may be impaired by local thicknesses.

Curvature is preferably understood to mean the deviation from a straight profile. Only the magnitude of the curvature (that is to say without consideration of a sign) is in particular intended to be taken into account here. The insulating gaps separate the track sections, which are separated from one another, such that a flow of current from one to the other separated track section (through the insulating gaps) is ruled out (or is at least significantly reduced). A specific resistance of the insulating gaps, in comparison with the track sections that are separated from one another, is preferably at least 10 times, even more preferably at least 50 times greater. A first and/or second track section should in particular be considered to be designed so as to be substantially straight if a deviation from a (straight) connecting line between a start and an end of the respective track section is at most 10%, preferably at most 5%, even more preferably at most 2%. A curvature in the deflection section is preferably at least 2 times, even more preferably at least 5 times, even more preferably at least 10 times larger (on average) than a curvature of the first and/or second track section. The first and/or second track section in particular (directly) adjoin the deflection section. The first and/or second track section may be at least as long, preferably at least 1.5 times as long, even more preferably at least 3 times as long as the deflection section.

Overall, what is proposed is an electrical heating device that is in particular effectively able to cover the increasing demand in electrically driven vehicles (due to the increasing prevalence thereof). In the past, what are known as PTC heating elements were predominantly used as electrical heating devices for such mobile applications, these having been operated with comparatively low supply voltages that are present in an on-board power system of a conventional motor vehicle having an internal combustion engine. In particular in modern vehicles that are fully or partly electrically driven, there is the need also to be able to electrically operate the vehicles with the supply voltages that are present in a high-voltage on-board power system provided therein, such as for example a voltage in a range of between 150 volts and 900 volts, possibly even up to more than 1000 volts.

A heating device for mobile applications is understood in the present context to mean a heating device that is designed for use in mobile applications and is tailored accordingly. This means in particular that it is transportable (possibly fixedly installed in a vehicle or just accommodated therein for transport purposes) and is not designed just for permanent, stationary use, as is the case for example in a building heating system. The heating device may weigh less than 500 kg, preferably less than 100 kg, even more preferably less than 20 kg. The heating device may possibly be fixedly installed in a vehicle (land vehicle, ship, etc.), in particular in a land vehicle. It may be designed in particular to heat a vehicle interior, such as for example of a land vehicle, watercraft or aircraft, and a (partly) open space, as is found for example on ships, in particular yachts. The heating device may also be (temporarily) used in a stationary manner, such as for example in large tents, containers (for example building containers), et cetera. The electrical heating device may be designed in particular for mobile applications as a standing heater or auxiliary heater for a land vehicle, such as for example for a caravan, a campervan, a bus, a car, etc.

The heat-conducting track may be deflected by at least 90 degrees, preferably by at least 120 degrees, even more preferably by at least 150 degrees (in particular by at least approximately 180 degrees) in the deflection section.

The substrate may have a planar or non-planar (for example bulging or curved) surface. The multiplicity of track sections (running adjacent to one another), separated from one another by insulating gaps, is preferably arranged at an (at least substantially) even height with respect to the substrate surface.

The first and second conductor section preferably run (at least sectionally) parallel to one another (in the geometrical sense). The deflection section preferably brings about a deflection by 180 degrees or at least approximately 180 degrees (that is to say in particular by at least 170 degrees). In a design of this type, the potential (local) heating is particularly pronounced, such that, by way of the additional conductor tracks in the region of the deflections, (local) heating is able to be reduced or prevented particularly effectively.

An inner branch track is designed so as to be narrower (at least on average and/or at least sectionally, preferably completely) with respect to an outer branch track. A measure of this type also makes the current distribution even more even.

The branch tracks preferably extend over at most 70%, more preferably at most 30%, even more preferably at most 15% and/or preferably at least 5%, even more preferably at least 10% of the first and/or second track section. A branching point is thus preferably situated only just upstream of the deflection section, which allows comparatively simple production while still effectively keeping the current distribution even.

In one embodiment, the heat-conducting track in the first track section or in the deflection section branches into at least three (or precisely three) branch tracks that are separated from one another by branch insulating gaps, the branch tracks meeting up again in the second conductor section or in the deflection section. The current distribution is thereby able to be made even more even.

The branch tracks may be arranged at the same height with respect to a surface of the substrate and/or have an identical thickness (perpendicular to the surface of the substrate).

A distance between adjacent track sections having mutually opposing current flow directions may be designed so as to be (locally) widened in the region of the deflection section. Through the combination of the branch tracks with such a (local) widening of the distance, the formation of hotspots is able to be particularly reliably suppressed. In principle, however, it is also possible to dispense with such a (local) widening of the distance, such that an improved utilization of the area of the surface of the substrate is achieved.

The at least one heat-conducting track may extend on the substrate in a bifilar pattern. Through a bifilar arrangement, the heat-conducting track is able to cover the surface provided by the substrate to a large extent with few empty areas. The bifilar arrangement furthermore makes it possible to minimize possible interfering radiation through the electrical heating device. In the bifilar arrangement, track sections of the heat-conducting track lie adjacent to one another such that track sections through which current flows or is able to flow in opposing directions are in each case arranged so as to run adjacent to one another. In this case, at least substantially all of the track sections of the heat-conducting track that are provided for heating purposes may preferably be part of the bifilar arrangement. As a result, the electromagnetic fields that are produced may at least partially cancel one another out. However, it should be borne in mind that in particular connection regions for connection to an electric power supply may also be arranged in a non-bifilar manner. The remaining regions of the heat-conducting track may preferably be arranged at least substantially in a bifilar manner.

The heat-conducting track may have at least two or at least three deflection sections. These (plurality of) deflection sections may each be assigned corresponding branch tracks. If the heat-conducting track has (precisely) two deflection sections (in particular deflected by 180 degrees), it is possible to produce an optimized bifilar arrangement that has low electromagnetic irradiation and in this case has only few regions in which an increased temperature occurs during operation. In the case of a plurality of heat-conducting tracks formed on the substrate, each of the heat-conducting tracks may preferably each have (precisely) two reversal points.

In one specific embodiment, the heat-conducting layer covers at least 80% of the substrate surface, preferably at least 85% of the substrate surface. This case gives a comparatively good utilization of the available substrate surface, while nevertheless still allowing sufficient insulation of the individual track sections from one another. The heat-conducting layer may in particular cover less than 95% of the substrate surface.

An electrically insulating material is preferably arranged in the insulating gaps. The electrically insulating material may preferably also cover that surface of the heat-conducting track or heat-conducting tracks that faces away from the substrate in addition to the insulating gaps. The electrically insulating material may in particular preferably be deposited as a layer after the formation of the heat-conducting track or of the heat-conducting tracks. The electrically insulating material is preferably (comparatively highly) electrically insulating, on the one hand, but (comparatively highly) thermally conductive, on the other hand. By virtue of the electrically insulating material, the width of the insulating gaps is able to be kept comparatively small, such that the available surface of the substrate is able to be utilized efficiently for the heat-conducting track or heat-conducting tracks.

According to one development, the heat-conducting track is designed such that in each case two track sections with an identically oriented current flow direction run adjacent and possibly parallel to one another at least over a predominant proportion of its length. The heat-conducting track may in particular be designed such that in each case two conductor track sections with an identically oriented current flow direction run adjacent and parallel to one another over at least 80% of the length. The two respective track sections may be connected, at their ends, in particular in each case to a common connection section for connection to an electric power supply. Such a refinement allows a particularly expedient distribution of the current flowing in the electrical heating element, and thus a particularly homogeneous distribution of the heating power. This structure may furthermore be formed in a simple and inexpensive manner, and the available surface of the substrate is able to be utilized well in the process.

In one embodiment, the heat-conducting track is designed such that it runs straight over a predominant proportion of its length. By virtue of this as well, the substrate is effectively able to be equipped with the heat-conducting track.

According to one development, at least one further layer is formed on the heat-conducting layer. A plurality of layers may also in particular be formed on the heat-conducting layer. An insulating layer may preferably be formed on the heat-conducting layer, which insulating layer possibly also fills the insulating gaps between the track sections of the heat-conducting track. A sensor layer for monitoring the function of the electrical heating device may for example preferably also be formed on the insulating layer. The insulating layer makes it possible to provide a high degree of safety by additionally insulating current-carrying regions.

In one specific embodiment, the electrical heating device is a motor vehicle heating device. The electrical heating device may in this case be designed in particular to heat a fluid, such as for example air for an interior of the vehicle, or a liquid in a liquid circuit of the vehicle.

The abovementioned object is achieved in particular by a vehicle, preferably a motor vehicle, more preferably a car or a lorry, comprising an electrical heating device of the type described above.

The abovementioned object is furthermore achieved in particular through the use of an electrical heating device of the type described above for a vehicle, in particular a motor vehicle.

The design of the electrical heating device generally also has the advantage that no (or only a little) additional space is required on the substrate surface, such that efficient utilization of the available space is made possible. Overall, a comparatively simple and inexpensive design is possible. In one (predefined) profile of the heat-conducting track, the branch tracks make it possible to increase the achievable heating power per unit of area, since the possible heating power is determined primarily by critical points at which local hotspots may form. The more the heat-conducting track is deflected at the deflection section, the greater the effect that is achieved. The effect of the branch tracks is thus particularly pronounced when the deflection section brings about a deflection by (at least approximately) 180 degrees.

The heat-conducting layer is preferably a layer that is deposited over the area of the substrate and possibly then structured by removing material. This allows comparatively inexpensive production of the heat-conducting track or of the heat-conducting tracks. The heat-conducting layer may preferably be applied to the substrate using a thermal spraying method and then structured (for example through laser processing). In principle, however, other methods, such as for example printing methods, casting methods or the like, are also conceivable for forming the heat-conducting layer. Other structuring methods are likewise possible, such as for example etching, mechanical removal, ultrasound or the like. The heat-conducting layer is preferably manufactured from an electrically conductive, in particular metal material. The heat-conducting layer may furthermore be separated from the material of the substrate by an interposed, electrically insulating (and possibly highly thermally conductive) intermediate layer. The heat-conducting layer may in particular be formed for example from a nickel-chromium alloy and/or be separated from the material of the substrate by an aluminium oxide layer. The substrate may preferably have a comparatively good thermal conductivity, in particular be manufactured from a metal. The respective heat-conducting track may preferably have a width of a few millimetres, in particular a width of between 2.5 mm and 5 mm, and a thickness (in the direction perpendicular to the substrate) in the range from 5 μm to 30 μm, in particular in the range from 10 μm to 25 μm.

In one specific embodiment, the electrical heating device is designed as a high-voltage heater for an operating voltage in the region of preferably between 150 volts and 900 volts, more preferably between 200 volts and 600 volts. However, a design of possibly up to more than 1000 volts is also possible. In this case, the electrical heating device may particularly advantageously be used for example in an electric or hybrid vehicle, without the need for expensive voltage converters.

Further embodiments emerge from the dependent claims.

The disclosure is described below with reference to exemplary embodiments that are explained in more detail with reference to the drawings. In the figures:

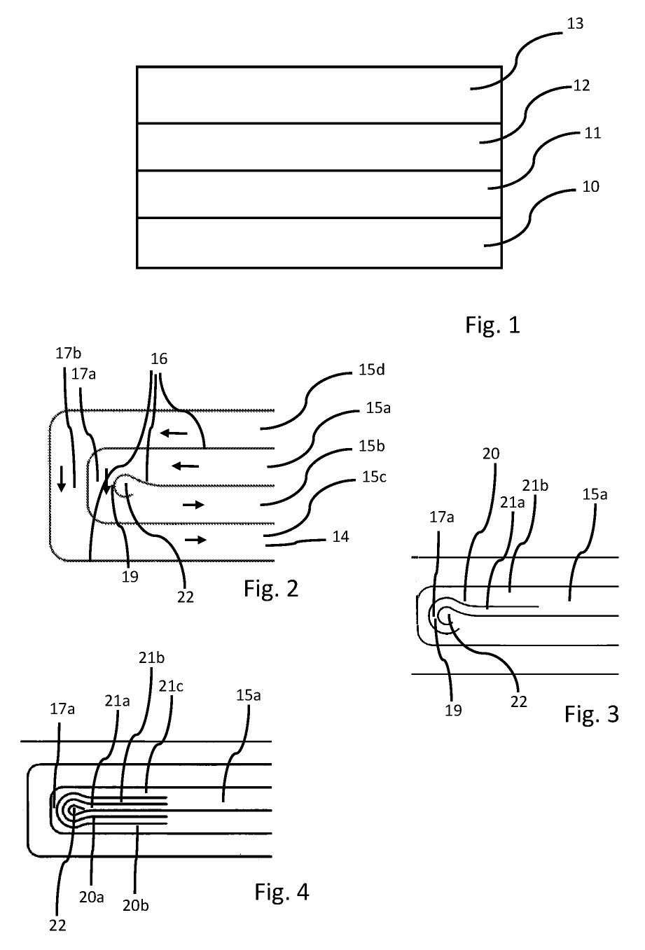

FIG. 1 shows a schematic sectional view of an electrical heating device according to the disclosure;

FIG. 2 shows a section of a heat-conducting layer according to a comparative example;

FIG. 3 shows a section analogous to FIG. 2, according to an exemplary embodiment according to the disclosure; and

FIG. 4 shows a section analogous to FIGS. 2 and 3 according to a further exemplary embodiment.

In the following description, the same reference signs are used for identical and functionally identical parts.

FIG. 1 shows a schematic section of a heating device according to the disclosure. Said heating device comprises a substrate 10, an electrically insulating layer 11 arranged (directly) on the substrate 10, a heat-conducting layer 12 arranged (directly) on the electrically insulating layer 11, and an insulating layer 13 arranged (directly) on the heat-conducting layer 12. The electrically insulating layer 11 and the insulating layer 13 are merely optional. The electrically insulating layer 11 is provided in particular when the substrate 10 is formed from a conductive material, for example metal.

The electrical heating device according to FIG. 1 is designed to heat a fluid in a vehicle. In this case, the fluid may be formed in particular by air to be heated or by a fluid in a fluid circuit of the vehicle. The electrical heating device is in this case in particular designed as a high-voltage heater for operation with an operating voltage in the range between 150 volts and 900 volts, in particular in the range between 200 volts and 600 volts. However, a design of for example up to more than 1000 volts is also possible.

The substrate 10 is in particular at the same time designed as a heat exchanger for transferring released heating power to the fluid to be heated. In particular, an underside (not shown) may be provided with a plurality of heat-exchange ribs and/or channels via which the fluid to be heated is guided. The substrate 10 may preferably (inexpensively from a production point of view) be formed from a metal material with a high heat transfer coefficient, in particular from aluminium or an aluminium alloy. It is also however possible in principle to manufacture the substrate 10 from an electrically insulating material with high thermal conductivity, such as in particular from a corresponding ceramic.

The electrically insulating layer 11 preferably has a high thermal conductivity. The electrically insulating layer 11 is furthermore preferably formed from aluminium oxide. The electrically insulating layer 11 may furthermore be deposited on the substrate 10 in a thermal spraying method. In particular in the event that the substrate is formed from aluminium or an aluminium alloy, the electrically insulating layer 11 may also be formed for example by targeted oxidation of the surface of the substrate 10. The electrically insulating layer 11 is designed to electrically insulate the substrate 10 from the heat-conducting layer 12 (but at the same time also to allow a good transfer of heat to the material of the substrate 10).

The heat-conducting layer 12 is preferably deposited on the substrate 10 (or on the insulating layer 11). The heat-conducting layer 12 may be formed from a metal material (in particular from a nickel-chromium alloy). The heat-conducting layer 11 is preferably deposited in a thermal spraying method. As an alternative, it is also however possible, for example, to deposit the heat-conducting layer 11 in a printing or casting method.

The heat-conducting layer 12 is structured such that at least one heat-conducting track is formed, this being designed to release resistive heat when an electric voltage is applied between its opposing ends. In principle, the heat-conducting track may be structured as described in WO 2013/186106 A1 (apart from the branch tracks in the region of the deflection sections, which will be described in more detail below).

In an edge region of the electrical heating device, there may be provided connections for connecting the heat-conducting tracks to an electric power supply. Such connections may be arranged above an edge of the substrate 10 (for example adjacent to one another) so as to be electrically insulated from one another. In this case, a first connection may be designed to make electrical contact with the heat-conducting track and apply a first electrical potential, and a second connection may be designed to make electrical contact with the heat-conducting track and apply a different second potential. A desired potential difference is thus able to be applied to the heat-conducting track via the two connections.

FIG. 2 shows a cutout of a comparative example for a structure of the heat-conducting layer 12. In general, this heat-conducting layer may be structured such that it extends on the substrate 10 in a bifilar pattern.

The heat-conducting layer has a heat-conducting track 14 that comprises a multiplicity of track sections 15a, 15b, 15c and 15d formed adjacent to one another. The track sections 15a to 15d are separated from one another by insulating gaps 16 and thus electrically insulated from one another. The insulating gaps may preferably be formed by virtue of the fact that the heat-conducting layer 12 is initially deposited over the area of the substrate 10 and the material of the heat-conducting layer 12 is then removed in a targeted manner in the region of the insulating gaps, in particular through laser processing. FIG. 2 schematically illustrates preferred current flow directions in the heat-conducting track 14 using arrows.

The insulating gaps 16 preferably have an (at least substantially) constant width (over their longitudinal extent). This achieves a situation whereby the track sections 15a to 15d of the heat-conducting track 14 are able to cover a large area of the surface of the substrate, such that the available area is able to be utilized as optimally as possible to form track sections that provide heating power.

The track sections 15a and 15b or 15c and 15d (which run straight) are connected to one another via deflection sections 17a and 17b. The heat-conducting track 14 (in a main plane) is deflected by (at least substantially) 180 degrees in the deflection section 17a, such that the conductor track sections 15a, 15b (with opposing current flow direction) run adjacent and parallel to one another, separated only by an insulating gap 16.

In the comparative example according to FIG. 2, a region 19 with a comparatively high current flow occurs in the reversal section 17a, since the flowing electric current predominantly seeks the path of least electrical resistance (or the shortest path). Such an inhomogeneous current distribution through the cross section of the heat-conducting track 14 leads to strong local heating in the region 19 through which electric current flows to a greater extent, such that the risk of hotspots exists there, which hotspots may negatively influence the lifetime of the electrical heating device due to strong heating. In the comparative example according to FIG. 2, maximum temperatures of 254° C. may arise in this case.

The problem of the formation of undesired hotspots is solved or at least alleviated through the formation of the heat-conducting layer 12 according to FIG. 3 (which illustrates an embodiment of the electrical heating device according to the disclosure in more detail). The heat-conducting layer 12 according to FIG. 3 may in particular be designed like the heat-conducting layer 12 according to FIG. 2 (according to the comparative example), with the following differences, which are explained in more detail. Upstream of the deflection section 17a, a first track section 15a branches off, such that the electric current flows over two paths that are insulated from one another (by branch insulating gaps). As a result, the current distribution is effectively moderated in comparison. A region 19 with an increased current density may still occur. However, this region 19 is far less pronounced than in the comparative example according to FIG. 2. Overall, the track section 15a thus branches into two branch sections 21a, 21b. These branch sections 21a, 21b meet up at the end of the deflection section 17a in the embodiment according to FIG. 3. With the same structure, apart from the branch sections, as in the comparative example according to FIG. 2, a considerably lower maximum temperature of just 226° C. occurs.

FIG. 4 shows a cutout of a further embodiment of the electrical heating device according to the disclosure. In contrast to the embodiment according to FIG. 3, the first track section 15a in this case branches into three branch sections 21a, 21b and 21c (separated by branch insulating gaps 20a, 20b). The current distribution is thereby able to be made even more even. In addition, in the embodiment according to FIG. 4, it is provided for the branch sections 21a to 21c to meet up again only at a distance with respect to an end of the deflection section 17a. The start and the end of the branch sections 21a to 21c thus lie adjacent to one another (in relation to the current direction). In principle, this may also be the case in the embodiment according to FIG. 3.

It is preferable (as illustrated schematically in FIGS. 3 and 4) for the inner branch section 21a or the two inner branch sections 21a and 21b (according to FIG. 4) to be designed so as to be narrower than the outer (outermost) branch section 21b or 21c (at least on average). As a result, a comparatively high proportion of the current is forced onto the branch sections lying further outward or the branch section lying further outward, which further counteracts the formation of a hotspot in the region 19.

As illustrated schematically in FIG. 1, at least one further insulating layer 13, which covers the upper side of the heat-conducting layer 12, facing away from the substrate 10, may be formed on the heat-conducting layer 12 or on the correspondingly structured heat-conducting tracks 14. The further insulating layer 13 is preferably in particular designed such that it also fills the insulating gaps 16, 20 between the track sections 15a to 15d. Particularly good insulation of the track sections 15a to 15d from one another is thereby ensured. The further insulating layer 13 may for example be deposited on the structured heat-conducting track 14 following the structuring of the heat-conducting layer 12. The deposition may in this case preferably be performed for example using a thermal spraying method, a casting method or the like. In particular, the further insulating layer 13 may be formed for example by aluminium oxide, so as to achieve good electrical insulation and at the same time good thermal conductivity.

One or more further layers is/are additionally preferably applied to the further insulating layer 13. It may in particular be advantageous to form at least an additional sensor layer for monitoring the function of the electrical heating device.

A distance between adjacent track sections in the region of the deflection section 17a may be designed so as to be (locally) widened, such that the deflection of the heat-conducting track 14 encloses for example a (substantially) drop-shaped or match-head-shaped region 22. In the embodiment that is specifically illustrated, the enclosed region 22 is electrically conductively connected to one of the track sections, namely the track section 15b (that is to say no gap in the heat-conducting layer is formed with respect to this conductor 15b). However, it is also possible for example to completely separate the enclosed region 22 from the inner track sections by way of an insulating gap. By virtue of the local widening of the distance between the inner track sections in the region of the deflection section 17a, an excessive length difference between current paths on the outer edge of the inner track sections and current paths on the inner edge of the inner track sections is avoided, such that an excessive concentration of the current flow on the inner side at the deflection sections is further prevented. Through synergistic interaction with the branch sections that are provided, local heating is thereby effectively able to be avoided.

It is pointed out at this juncture that all of the parts described above, considered individually and in any combination, in particular the details illustrated in the drawings, are comprised in the disclosure. Amendments thereto are familiar to those skilled in the art.

### REFERENCE SIGNS

10 substrate
11 electrically insulating layer
12 heat-conducting layer
13 insulating layer
14 heat-conducting track
15a track section
15b track section
15c track section
15d track section
16 insulating gap
17a deflection section
17b deflection section
19 region
20 branch insulating gap
20a branch insulating gap
20b branch insulating gap
21a branch section
21b branch section
21c branch section
22 region

1. Electrical heating device for mobile applications, having:
a substrate and a heat-conducting layer formed on the substrate, wherein the heat-conducting layer has at least one heat-conducting track that is arranged on the substrate, wherein the heat-conducting track is structured such that a multiplicity of track sections, separated from one another by insulating gaps, is formed, wherein the heat-conducting track has at least one deflection section at which the heat-conducting track is deflected and which is arranged between a first and a second track section, wherein the first and the second track section have a smaller curvature in comparison with the deflection section, in particular are designed so as to be at least substantially straight, wherein the heat-conducting track in the first track section or in the deflection section branches into at least two branch tracks separated from one another by one or more branch insulating gaps, wherein the branch tracks meet up again in the second track section or in the deflection section.

2. Electrical heating device according to claim 1, wherein the first and second track section run at least sectionally parallel to one another and/or in that the deflection section brings about a deflection by at least approximately 180°.

3. Electrical heating device according to claim 1, wherein an inner branch track is designed so as to be narrower with respect to an outer branch track, at least on average and/or at least sectionally, preferably completely.

4. Electrical heating device according to claim 1, wherein the branch tracks extend over at most 70%, preferably at most 30%, more preferably at most 15% and/or at least 5%, preferably at least 10%, of the first and/or second track section.

5. Electrical heating device according to claim 1, wherein the heat-conducting track in the first track section or in the deflection section branches into at least three branch tracks that are separated from one another by branch insulating gaps, the branch tracks meeting up again in the second track section or in the deflection section.

6. Electrical heating device according to claim 1, wherein the branch tracks are arranged at the same height with respect to a surface of the substrate and/or have an identical thickness perpendicular to the surface of the substrate.

7. Electrical heating device according to claim 1, wherein a distance between adjacent track sections having mutually opposing current flow directions is designed so as to be locally widened in the region of the reversal section and/or in that the at least one heat-conducting track extends on the substrate in a bifilar pattern.

8. Electrical heating device according to claim 1, wherein the heat-conducting track has at least two or at least three deflection sections.

9. Electrical heating device according to claim 1, wherein the heat-conducting layer covers at least 80% of the substrate surface, preferably at least 85% of the substrate surface and/or wherein an electrically insulating material is arranged in the insulating gaps and/or
the heat-conducting track is designed such that in each case two track sections with an identically oriented current flow direction run adjacent and parallel to one another at least over a predominant proportion of its length and/or
the heat-conducting track is designed such that it runs straight over a predominant proportion of its length, and/or
wherein at least one further layer, in particular an insulating layer, is formed on the heat-conducting layer.

10. Electrical heating device according to claim 1, wherein the electrical heating device is a motor vehicle heating device.

11. Vehicle, in particular motor vehicle, comprising an electrical heating device according to claim 1.

12. Use of an electrical heating device according to claim 1, in a motor vehicle.
